(19) United States
(12) Patent Application Publication
(10) Pub. No.: US 2008/0279609 A1
(43) Pub. Date: Nov. 13, 2008

(54) Paper detection device of label printer

(76) Inventor: Ching-Wen Chen, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/149,710

(22) Filed: May 7, 2008

(30) Foreign Application Priority Data
May 8, 2007 (TW) 096207364

(51) Int. Cl. B41J 29/00

(52) U.S. Cl. 400/708

(57) ABSTRACT

A paper detection device is provided for a label printer, including an enclosure and at least one detection circuit board. The enclosure has opposite side faces on which at least one guide rail and a handle are formed and a bottom on which at least one resilient stop block is formed. The enclosure forms at least one detection channel through which a label to be printed is allowed to pass therethrough. The detection circuit board is arranged inside the enclosure to detect the label passing through the detection channel. The guide rails formed on the opposite sides of the enclosure allow the paper detection device to be fit into a receptacle pre-formed inside the label printer and the handle allows a user to move the enclosure by pulling the handle to thereby adjust the position of the enclosure inside the receptacle. The resilient stop block on the bottom of the enclosure facilitates to secure and position the enclosure inside the receptacle. Further, by lifting the handle to detach the resilient stop block from the receptacle, the enclosure can be slid out of the receptacle to dismount the paper detection device from the label printer. Thus the device of the present invention is a paper detection device that can be mounted/dismounted by operating the handle.

### BACKGROUND OF THE INVENTION

1. Field of the Invention

The present invention relates to a paper detection device of a label printer, and in particular to a paper detection device that comprises a handle and a resilient stop block to facilitate positioning/mounting/removal of the paper detection device in/out of the label printer.

2. The Related Arts

A conventional label printer is constructed to fix labels to be printed therein. Thus, for labels of different sizes, label papers of different sizes are provided and detection of the label papers must be exercised. Thus, the conventional label printer is often provided with a paper detection device arranged in the conveyance router of the label paper inside the label printer. Heretofore, the conventional paper detection device is fixedly secured inside the housing of the label printer, which prevents the paper detection device from easily mounting and positioning inside the label printer. In addition, the paper detection device that is fixedly secured in the label printer cannot be easily detached and removed. And this causes troubles to the maintenance and repairing of the paper detection device.

Thus, it is desired to provide a paper detection device for a label printer, which eliminates the drawbacks/problems associated with mounting and removal of the paper detection device into/out of the label printer occurring in the conventional paper detection devices.

### SUMMARY OF THE INVENTION

An objective of the present invention is to provide a paper detection device, which comprises guide rails and a handle to ease the installation operation thereof by allowing the paper detection device to be pulled to the desired installation position.

Another objective of the present invention is to provide a paper detection device for a label printer, which comprises a resilient stop block to allow for easy positioning/mounting/dismounting of the paper detection device.

To achieve the above discussed objectives, in accordance with the present invention, a paper detection device for a label printer, comprising an enclosure and at least one detection circuit board, wherein the enclosure has opposite side faces on which at least one guide rail and a handle are formed and a bottom on which at least one resilient stop block is formed. The enclosure forms at least one detection channel through which a label to be printed is allowed to pass therethrough. The detection circuit board is arranged inside the enclosure to detect the label passing through the detection channel. The guide rails formed on the opposite sides of the enclosure allow the paper detection device to be fit into a receptacle pre-formed inside the label printer and the handle allows a user to move the enclosure by pulling the handle to thereby adjust the position of the enclosure inside the receptacle. The resilient stop block on the bottom of the enclosure facilitates to secure and position the enclosure inside the receptacle. Further, by lifting the handle to detach the resilient stop block from the receptacle, the enclosure can be slid out of the receptacle to dismount the paper detection device from the label printer to realize mounting/dismounting of the paper detection device into/out of the label printer.

### BRIEF DESCRIPTION OF THE DRAWINGS

The present invention will be apparent to those skilled in the art by reading the following description of preferred embodiment thereof, with reference to the attached drawings, wherein:

FIG. 1 is a perspective view of a paper detection device constructed in accordance with the present invention for use with a label printer;

FIG. 2 is another perspective view of the paper detection device of the present invention;

FIG. 3 is an exploded view of the paper detection device of the present invention;

FIG. 4 is a perspective view illustrating of an application of the paper detection device in a label printer; and

FIG. 5 is a front view of FIG. 4.

### DETAILED DESCRIPTION OF THE PREFERRED EMBODIMENT

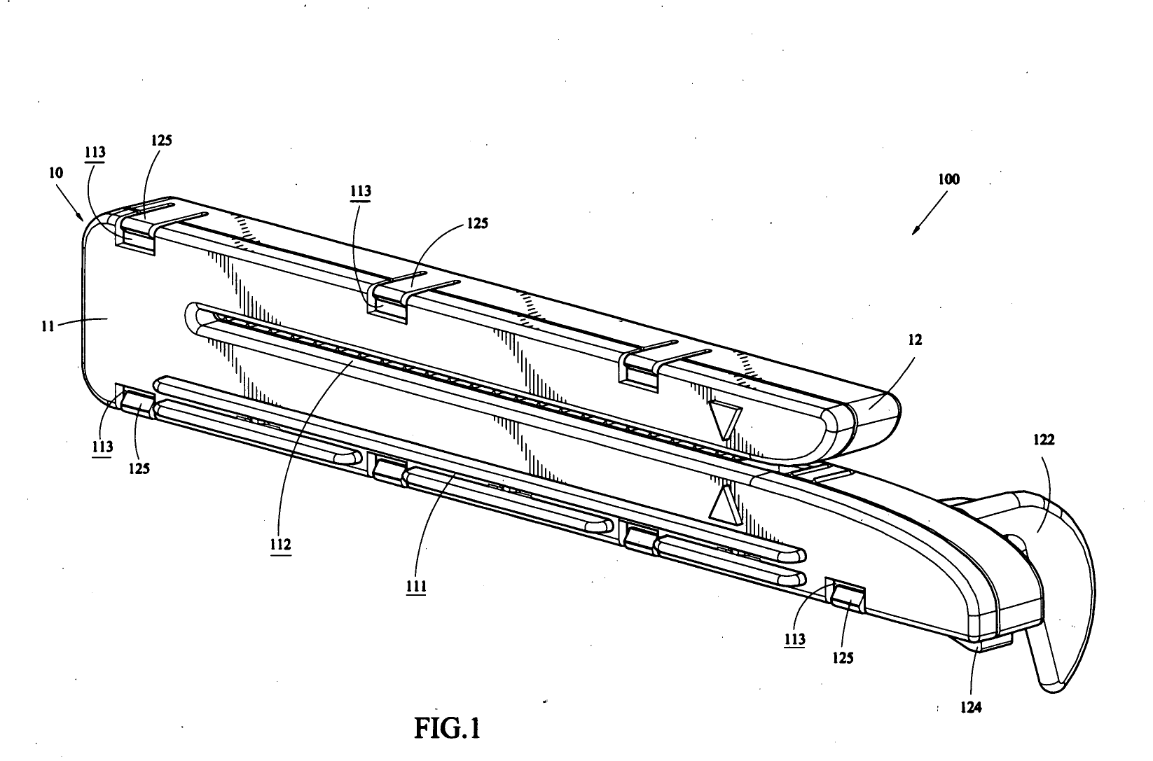

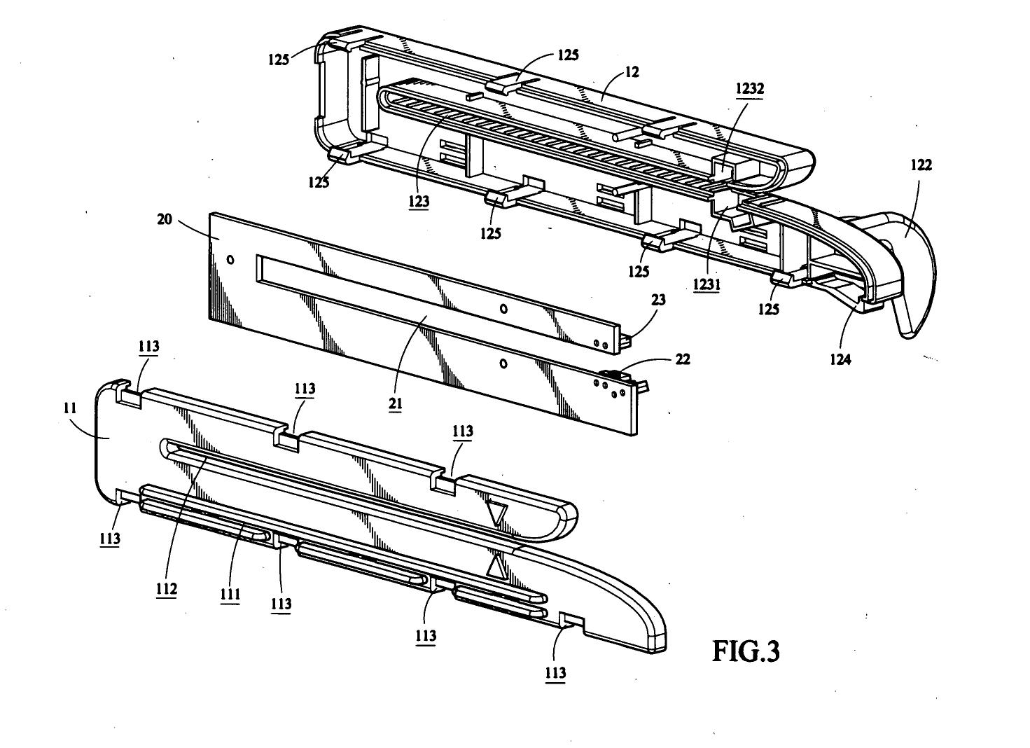

With reference to the drawings and in particular to FIGS. 1-3, a paper detection device constructed in accordance with the present invention, generally designated with reference numeral 100, is provided for a label printer. The paper detection device 100 comprises an enclosure 10 and at least one detection circuit board 20. The enclosure 10 comprises a first casing member 11 and a second casing member 12, which can be of corresponding outlines and mate each other to form the enclosure 10. The first casing member 11 forms on an outside face thereof a guide rail 111. The first casing member 11 also forms at least one detection channel 112. A plurality of cut-offs 113 is defined along a circumference of the first casing member 11.

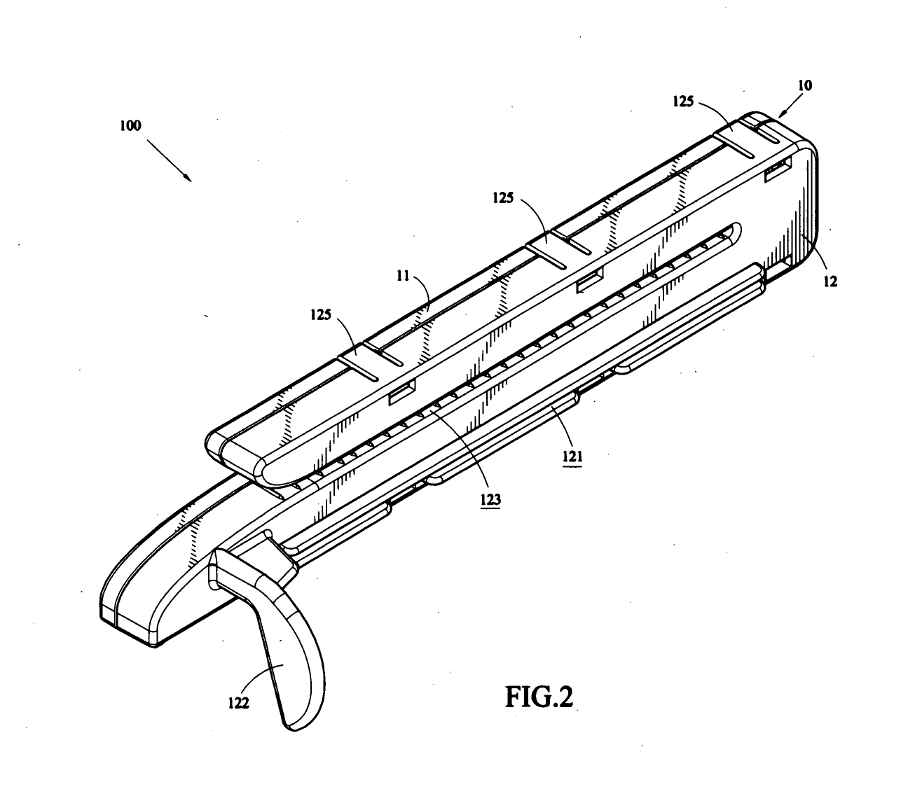

The second casing member 12 forms on an outside face thereof a guide rail 121 and a handle 122 (as best seen in FIG. 2). The second casing member 12 also forms at least one detection channel 123, which corresponds in position and shape to the detection channel 112 of the first casing member 11. A plurality of detection opening 1231, 1232 are formed inside the detection channel 123, preferably on opposite sides or banks of the detection channel 123. The second casing member 12 has a bottom on which a resilient stop block 124 is formed. The second casing member 12 forms a plurality of pawls 125 distributed along a circumference thereof and engageable with the cut-offs 113 of the first casing member 11 to fix the first and second casing member 11, 12 together to form the enclosure 10.

Although the enclosure 10 can be formed of the combination of the first and second casing members 11, 12, yet it is apparent that the enclosure 10 can be made of any desired form and construction. This is apparently within the scope of the present invention.

The detection circuit board 20 is enclosed by the first and second casing members 11, 12. The detection circuit board 20 forms a slot 21, which corresponds in position to the detection channel 112 of the first casing member 11 and the detection channel 123 of the second casing member 12. The detection circuit board 20 is provided with a first sensor 22 and a second sensor 23, which correspond to the detection openings 1231, 1232 of the detection channel 123 of the second casing member 12 respectively, whereby the first sensor 22 and the second sensor 23 can detect an object passing through the detection channels 112, 123.

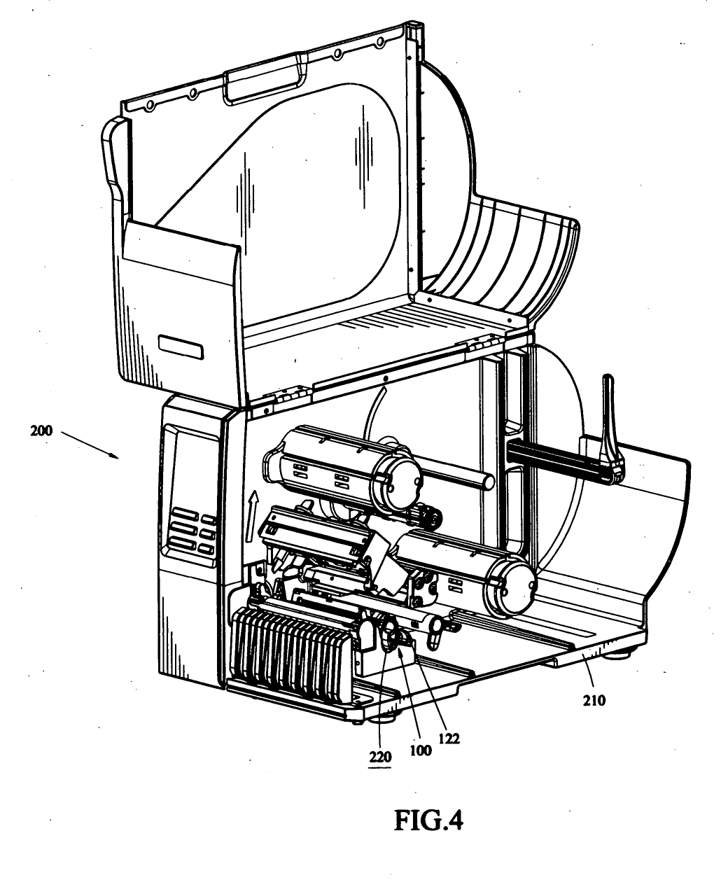

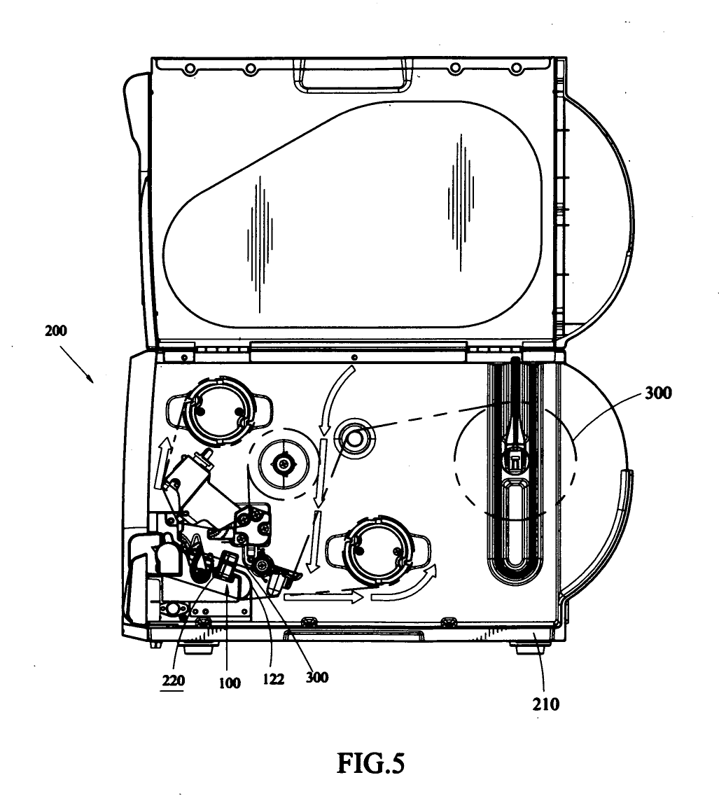

Also referring to FIGS. 4 and 5, installation of the paper detection device 100 in a label printer, which is designated with reference numeral 200, is illustrated. The paper detection device 100 is accommodated in a pre-formed receptacle 220 defined inside a housing 210 of the label printer 200. The guide rails 111, 121 formed on the outside faces of the first and second casing members 11, 12 of the enclosure 10 are respectively fit into corresponding portions formed inside the receptacle 220 to allow the paper detection device 100 to be slidable within the receptacle 220. Further, the handle 122 that is provided on the second casing member 12 allows for manual adjustment and setting of the position of the paper detection device 100 within the receptacle 220. The resilient stop block 124 on the bottom of the second casing member 12 is engageable with, under the biasing force induced by the resiliency thereof, a pre-formed notch (not shown) defined in the receptacle 220 to thereby secure and prevent the paper detection device 100 from slipping out or detaching from the receptacle 220. The detection channels 112, 123 of the first and second casing members 11, 12 are set at a route of a label to be printed 300 to allow the label 300 to pass therethrough. The first and second sensors 22, 23 of the detection circuit 20 that correspond to openings 1231, 1232 located on opposite sides of the channel 123 of the second casing member 12 can detect and identify the status of the label 300 passing through the channel.

To remove the paper detection device 100 out of the receptacle 220 of the label printer 200, a user may move the paper detection device 100 to a preset position by pulling the handle 122, following by slightly lifting the handle 122 upwards to allow the resilient stop block 124 on the bottom of the second casing member to detach from the corresponding notch of the receptacle 220, and as such, the paper detection device 100 is allowed to remove out of the receptacle 220 in a simple and convenient manner.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A paper detection device adapted to use in a label printer, comprising:
an enclosure having opposite side faces on which guide rails are formed respectively for fitting into corresponding portions formed inside a receptacle defined in the label printer, the enclosure forming at least one detection channel adapted to allow a label to be printed to pass therethrough, the enclosure having a bottom forming a resilient stop block engageable with a notch defined in the receptacle of the label printer; and
at least one detection circuit board arranged inside the enclosure to detect the label passing through the detection channel.

2. The paper detection device as claimed in claim 1 further comprising a handle mounted to one side of the enclosure.

3. The paper detection device as claimed in claim 1, wherein the enclosure comprises:
a first casing member having an outside face on which one of the guide rails is formed, the first casing member forming a first channel;
a second casing member having an outside face on which one of the guide rails is formed, the second casing member forming a second channel, the second casing member having a bottom on which the resilient stop block is formed,
wherein the second casing member mates the first casing member to form the enclosure and the first and second channel together form the detection channel.

4. The paper detection device as claimed in claim 3, wherein the first casing member has a circumference along which cut-offs are defined.

5. The paper detection device as claimed in claim 3, wherein the second casing member forms the handle.

6. The paper detection device as claimed in claim 3, wherein the second casing member has a circumference along which pawls are formed.

7. The paper detection device as claimed in claim 3, wherein the second channel of the second casing member forms a plurality of detection openings.
